(19) United States
(12) Patent Application Publication
(10) Pub. No.: US 2005/0028151 A1
(43) Pub. Date: Feb. 3, 2005

(54) Module symbol export

(76) Inventors: Steven T. Roth, Sunnyvale, CA (US); Aswin Chandramouleeswaran, Santa Clara, CA (US); C.P. Vijay Kumar, Sunnyvale, CA (US); Eric W. Hamilton, Mountain View, CA (US); Carl E. Davidson, Los Gatos, CA (US); Zheng Zhang, San Jose, CA (US)

Correspondence Address: HEWLETT-PACKARD COMPANY;Intellectual Property Administration, P.O. Box 272400, Fort Collins, CO, 80527-2400, US

(21) Appl. No.: 10/927,859

(22) Filed: Aug. 27, 2004

Related U.S. Application Data
(63) Continuation-in-part of application No. 10/440,144, filed on May 19, 2003.

(51) Int. Cl. G06F 9/44

(52) U.S. Cl. 717/162

(57) ABSTRACT

Systems, methods, and devices are provided for handling module symbols. One embodiment includes a module link tool having a processor, a memory, and program instructions provided to the memory and executable by the processor. The program instructions are executable to translate a particular type of information associated with an object file into instructions to provide to a linker utility.

### RELATED APPLICATION

The present application is a continuation in part and claims priority to U.S. patent application Ser. No. 10/440,144, filed May 19, 2003, entitled “Self-Describing Kernel Modules”, the disclosure of which is incorporated by reference herein in its entirety.

### BACKGROUND

Before a computing device may accomplish a desired task, it must receive an appropriate set of instructions. Executed by a device's processor(s), these instructions direct the operation of the device. These instructions can be stored in a memory of the computer. Instructions can invoke other instructions.

A computing device, such as a server, router, desktop computer, laptop, etc., and other devices having processor logic and memory, includes an operating system layer and an application layer to enable the device to perform various functions or roles. The operating system layer includes a “kernel”, i.e., master control program, that runs the computing device. The kernel provides task management, device management, and data management, among others. The kernel sets the standards for application programs that run on the computing device and controls resources used by application programs. The application layer includes programs, i.e., executable instructions, which are located above the operating system layer and accessible by a user. As used herein, “user” space, or “user-mode” implies a layer of code which is less privileged and more directly accessible by users than the layer of code which is in the operating system layer or “kernel” space.

In software development, there can be many different groups of programmers working on different portions of software code that will later be compiled to create a finished program. A compiler is software that converts a set of high-level language statements (e.g., high level programming language such as C/C++, COBOL, etc.) into a lower-level representation. For example, compiler software translates a program written in a high-level programming language (C/C++, COBOL, etc.) into machine language. A compiler may generate assembly language first and then translate the assembly language into machine language. A utility known as a “linker” then combines all required machine language modules into an executable program that can run in the computer.

A piece of code, e.g., code in a kernel module, can have functions or variables (collectively “symbols”) which are visible to other modules using that code, and other symbols which are not. In the C language, any symbol that has the “extern” storage class is typically referred to as a “global symbol” and is visible to other modules, i.e., shared between files. Since the C language requires any symbol shared between files within the module to be global, this can result in symbols being visible to across modules when it may be better that they not be. For example, modules can come from a variety of sources and suppliers, e.g. module developers, who may or may not know about one another. As a result one source and/or supplier's global symbols may not be known by another. Where multiple modules make the same symbol visible, namespace collisions can occur, resulting in either build breakage or potentially significant system misbehavior.

Another issue concerns the manner in which a linker tool combines modules into an executable program that can run in the computer. The linker tool takes object files as input and builds a binary, i.e., a file containing machine language instructions, out of them. The linker includes object files that are; (1) listed explicitly in the command line, e.g. usually required object files, and (2) contained in libraries listed on the command line and needed to satisfy symbol references from each other or the explicitly listed object files.

However, in a general operating system kernel, there may be various object files that do not fit into either of the above categories. Examples of object files that do not fit into either of the above categories include object files with the following: (1) debug information; (2) “what” string information; and (3) symbols that may be required by loadable modules, e.g., DLKMs (dynamically loadable kernel modules) that are not yet loaded.

In at least one traditional Unix system, these object files were included into the kernel as follows. The “what” strings from libraries were extracted from the libraries and added into a new C source file and then compiled before the kernel was linked. The debug information was packaged into a separate library from which the object files were extracted and listed explicitly on the linker command line. This collection of all modules' debug information into a single library violates basic concepts of modularity that are understood by one of ordinary skill in the art. This approach is not available to third parties, i.e., customer users, and does not work for loadable modules. In other cases, the object files with interfaces to be used only by loadable modules were forced into the kernel by having a fake interface that called these interfaces or by packaging the desired interfaces into object files that would be linked anyway (also a violation of modularity).

### BRIEF DESCRIPTION OF THE DRAWINGS

FIG. 1 is a block diagram of a computer system suitable to implement embodiments of the invention.

FIG. 2 is a block diagram embodiment of a software system including a development system suitable to implement embodiments of the invention which can be executed on the computer system of FIG. 1.

FIG. 3 is a block diagram of an embodiment of a development system suitable to implement embodiments of the invention.

FIG. 4 serves to illustrate considerations which exemplify the benefits of a module link tool and program embodiments of the present invention.

FIG. 5 serves to illustrate additional considerations which exemplify the benefits of a module link tool and program embodiments of the present invention.

FIGS. 6-7 illustrates various method embodiments for handling module symbols.

### DETAILED DESCRIPTION

Program instructions are provided which execute to implement self descriptive data for a module within a build mechanism. The self descriptive data includes a list of symbols that a module wants to have visible to its users, along with a notation indicating that all other symbols are to be hidden. A build mechanism is provided which executes instructions to translate the self descriptive data into readable instructions for a linker utility. By allowing developers control over which of their global symbols are visible to their users, the potential for namespace collisions can be reduced and system reliability can be increased. Additionally, embodiments are provided to instruct to a linker to include object files with: (1) debug information; (2) “what” string information; and (3) symbols that may be required by loadable modules, e.g., DLKMs that are not yet loaded.

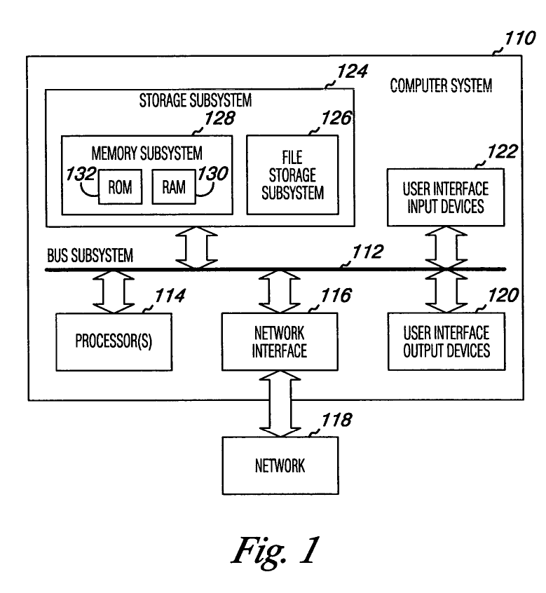

FIG. 1 is a block diagram of a computer system 110 suitable to implement embodiments of the invention. Computer system 110 includes at least one processor 114 which communicates with a number of other computing components via bus subsystem 112. These other computing components may include a storage subsystem 124 having a memory subsystem 126 and a file storage subsystem 128, user interface input devices 122, user interface output devices 120, and a network interface subsystem 116, to name a few. The input and output devices allow user interaction with computer system 110. Network interface subsystem 116 provides an interface to outside networks, including an interface to network 118 (e.g., a local area network (LAN), wide area network (WAN), Internet, and/or wireless network, among others), and is coupled via network 118 to corresponding interface devices in other computer systems. Network 118 may itself be comprised of many interconnected computer systems and communication links, as the same are known and understood by one of ordinary skill in the art. Communication links as used herein may be hardwire links, optical links, satellite or other wireless communications links, wave propagation links, or any other mechanisms for communication of information.

User interface input devices 122 may include a keyboard, pointing devices such as a mouse, trackball, touchpad, or graphics tablet, a scanner, a touchscreen incorporated into a display, audio input devices such as voice recognition systems, microphones, and other types of input devices. In general, use of the term “input device” is intended to include all possible types of devices and ways to input information into computer system 110 or onto computer network 118.

User interface output devices 120 may include a display subsystem, a printer, a fax machine, or non-visual displays such as audio output devices. The display subsystem may be a cathode ray tube (CRT), a flat-panel device such as a liquid crystal display (LCD) and/or plasma display, or a projection device (e.g., a digital light processing (DLP) device among others). The display subsystem may also provide non-visual display such as via audio output devices. In general, use of the term “output device” is intended to include all possible types of devices and ways to output information from computer system 110 to a user or to another machine or computer system 110.

Storage subsystem 124 can include the operating system “kernel” layer and an application layer to enable the device to perform various functions, tasks, or roles. File storage subsystem 126 can provide persistent (non-volatile) storage for additional program and data files, and may include a hard disk drive, a floppy disk drive along with associated removable media, a compact digital read only memory (CD-ROM) drive, an optical drive, or removable media cartridges. Memory subsystem 128 typically includes a number of memories including a main random access memory (RAM) 130 for storage of program instructions and data during program execution and a read only memory (ROM) 132 in which fixed instructions are stored. As used herein, a computer readable medium is intended to include the types of memory described above. Program embodiments as will be described further herein can be included with a computer readable medium and may also be provided using a carrier wave over a communications network such as the Internet, among others.

Bus subsystem 112 provides a mechanism for letting the various components and subsystems of computer system 110 communicate with each other as intended. Although bus subsystem 112 is shown schematically as a single bus, alternate embodiments of the bus subsystem 112 may utilize multiple busses.

Program embodiments according to the present invention can be stored in the memory subsystem 128, the file storage subsystem 126, and/or elsewhere in a distributed computing environment as the same will be known and understood by one of ordinary skill in the art. Due to the ever-changing nature of computers and networks, the description of computer system 110 depicted in FIG. 1 is intended only as one example of a computing environment suitable for implementing embodiments of the present invention. Many other configurations of computer system 110 are possible having more or less components than the computer system depicted in FIG. 1.

Computing networks can include multiple computing devices such as servers, desktop PCs, laptops, and workstations, among other peripheral devices, e.g., printers, facsimile devices, and scanners, networked together across a local area network (LAN) and/or wide area network (WAN). A LAN and/or WAN uses clients and servers that have network-enabled operating systems such as Windows, Mac, Linux, and Unix. An example of a client includes a user's workstation. Clients and servers can be connected in a client/server relationship in which the servers hold programs and data that are shared by the clients in the computing network.

As mentioned above, the kernel layer of a computer system manages the set of processes that are running on the system by ensuring that each process is provided with processor and memory resources at the appropriate time. A process refers to a running program, or application, with input, output, and a state. The kernel provides a set of services that allow processes to interact with the kernel and to simplify the work of an application writer. The kernel's set of services is expressed in a set of kernel modules. A module is a self contained set of instructions designed to handle particular tasks within a larger program. Kernel modules can be compiled and subsequently linked together to form a kernel. Other types of modules can be compiled and subsequently linked together to form other types of programs.

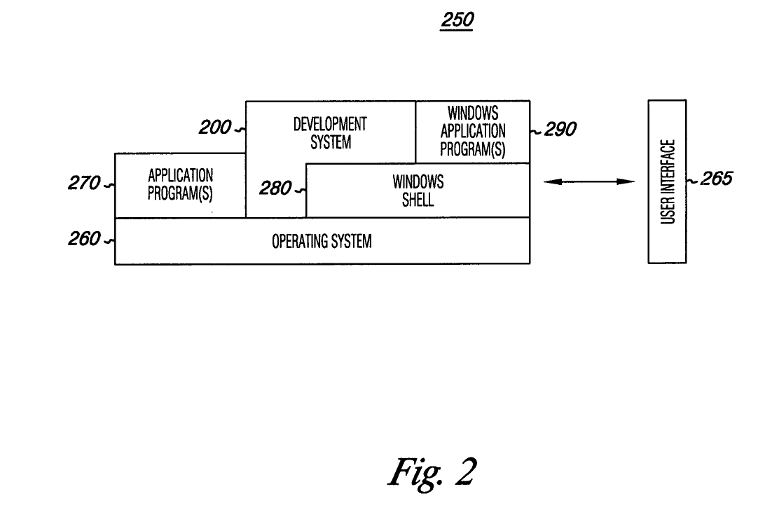

FIG. 2 is a block diagram embodiment of a software system 250 executable on the computer system such as shown in FIG. 1. The software system 250 illustrated in FIG. 2 can be provided to a computing system for controlling the operation of the computer system itself and/or another computing device within a network as described above. Software system 250, which can be stored in main memory, e.g., memory subsystem 126, includes a kernel or operating system layer 260 and a windows shell or interface 280. The operating system includes a number of linked kernel modules and can include the module embodiments discussed in more detail below. Programs are written in software code (i.e. computer executable instructions) by programmers for execution on computing devices and across computing networks. One or more application programs, such as application programs 270 or windows applications programs 290, may be “loaded” (i.e., transferred from file storage subsystem 128 into main memory 126) for execution by the computing system and/or across a network as shown in FIG. 1. Operating system 260 and shell 280, as well as application software 270 and 290, communicate with a user through an interface 265 for receiving commands and data and displaying results and other useful information. As shown in the embodiment of FIG. 2, the development system 200 includes components which can interface to a computing system through a windows shell 280, as well as components which interface directly through the operating system 260.

By way of example, and not by way of limitation, the operating system 260 of the computing system, e.g., system 110 in FIG. 1, can include a Unix, Linux, AIX, Windows, and/or Mac operating system, among others. The software system 250, including the development system 200, can be written in any suitable programming language, e.g., C, C++, Pascal, COBOL, Java, etc., as appropriate for interacting with a variety of software applications, including word processing, database, spreadsheet, text editors, and the like.

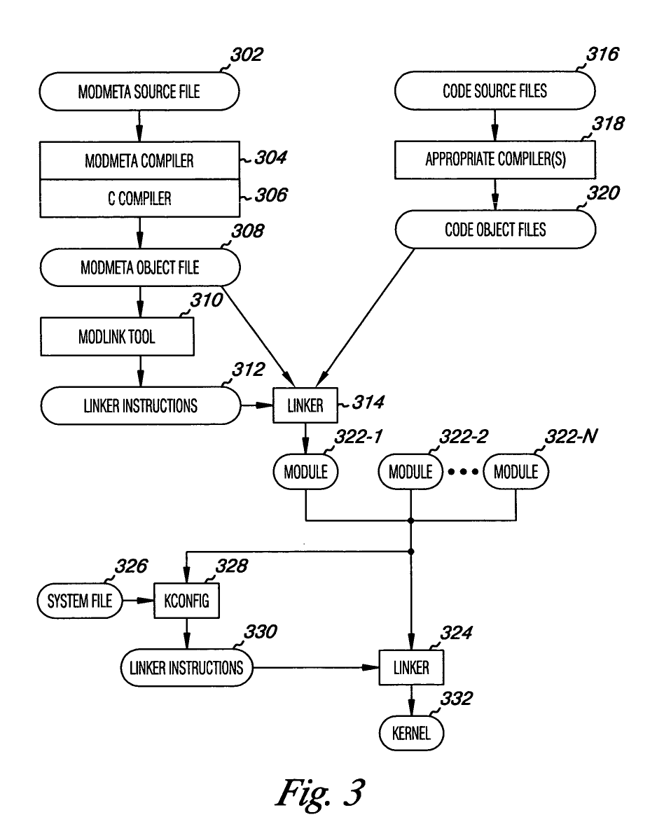

FIG. 3 is a block diagram illustrating an embodiment of a development system. One type of popular programming is modular programming which breaks down the design of a program into individual components (modules) that can be programmed and tested independently. FIG. 3 is discussed in relation to modular programming languages.

As shown in the embodiment of FIG. 3, the development system is provided with various code source files shown as 302 and 316, i.e., source files written in various high level programming languages. One or more code source files or code object files are packaged together into one or more modules, 322-1, 322-2, . . . , 322-N. As noted above, modules can come from a variety of sources and suppliers, e.g., module developers, who may or may not know about one another. As a result, namespace collisions may occur.

A piece of code, e.g., code in a kernel module, can have functions or variables (collectively “symbols”) which are visible to other modules, and symbols which are not. Functions and variables are known and understood by one of ordinary skill in the art. A function is a self-contained software routine that performs a task. Functions can do a large amount of processing or as little as adding two numbers and deriving a result. Functions in one code object file or module can be invoked (called) by code in the same or other code object file(s) or module(s). A variable is a structure that holds data and is uniquely named by the programmer. A variable holds the data assigned to it until a new value is assigned or the program is finished. A local variable is one that is referenced only within the subprogram, function or procedure it was defined in. A global variable can be used by the entire program.

As mentioned in the background, any symbol that is visible between code object files or modules is typically referred to as a “global symbol”. Where multiple modules make the same symbol visible, namespace collisions can occur, resulting in either build breakage or potentially significant system misbehavior.

As the reader will appreciate, a kernel is initially built with a basic set of modules. Each module contains executable code and data to provide some service to the kernel. Each module has an associated set of data that describes the module's capabilities and characteristics. These data have three audiences: the kernel itself needs the data to be able to use the module; kernel configuration (KC) tools that build the kernel need the data in order to resolve dependencies between modules; and the system administrator uses the data in order to decide which modules to choose.

As illustrated in FIG. 3, source files, shown as 302 and 316, can be passed through appropriate compilers 318 to create code object files 320 to export to the linker utility 314. One of ordinary skill in the art will appreciate that from the source code and “header” or “include” files, as the same are known and understood by one of ordinary skill in the art, an appropriate compiler “compiles” or generates object modules or files. For general background on the construction and operation of compilers, reference is made to Fischer et al., Crafting a Compiler with C, Benjamin/Cummings Publishing Company, Inc., 1991.

Upon successful creation of object files, the linker 314 “links” or combines the object files, e.g., 308 and 320 with standard libraries (e.g., graphics, I/O routines, startup code, and the like) to generate executable program modules, 322-1, 322-2, . . . , 322-N. As one of ordinary skill in the art will appreciate, a linker 314 is a tool which takes one or more of object files as input and builds a binary out of them, i.e. machine language. The linker includes object files that are; (1) listed explicitly in the command line, e.g. usually required object files, and (2) contained in libraries listed on the command line and needed to resolve symbol references from each other or the explicitly listed object files.

However, in a general program, there may be various object files that do not fit into either of the above categories. Examples of object files that do not fit into either of the above categories include object files with the following: (1) debug information; (2) “what” string information; and (3) symbols that may be required by loadable modules, e.g., DLKMs that are not yet loaded. As the reader will appreciate, “what” is the name of a standard Unix command that prints information about the version of a program or module (known as a “what” string). For example, for a module called “fred”, the command “what fred” would print the string, embedded in “fred”, that tells when it was built.

As noted above, in at least one traditional Unix system, these object files were included into the kernel as follows. The what strings from libraries were extracted from the libraries and added into a new C source file and then compiled before the kernel was linked. The debug information was packaged into a separate library from which the object files were extracted and listed explicitly on the linker command line. Again, this collection of all modules' debug information into a single library violated basic concepts of modularity that are understood by one of ordinary skill in the art. This approach is not available to third parties, i.e., customer users, and does not work for loadable modules. In other cases, the object files with interfaces to be used only by loadable modules were forced into the kernel by having a fake interface that called these interfaces or by packaging the desired interfaces into object files that would be linked anyway (also a violation of modularity).

To overcome the above described issues, embodiments of the present invention allow a module developer to specify a particular type of information to associate with an object file. The particular type of information is a list of symbols for the linker to include. The embodiments provide a build tool which can receive the particular type of information associated with an object file and translate the information into instructions provided to a linker utility.

As illustrated in FIG. 3, to achieve the above embodiments a module developer may make use of a module metadata source file 302 which may be written by a developer to embed various types of information which then become part of the module's self describing metadata object file 308. For example, the developer may write the module's metadata source file 302 to specify the following types of information: module name; module version; module type; description; supported states; supported load times; dependencies on other modules; interfaces or symbols exported by the module; tunable parameters; and initialization functions. The module metadata source file 302 may specify other information in addition to the examples given above.

According to various embodiments and as illustrated in FIG. 3, the present invention may involve the use of self-describing kernel modules. To implement such self describing kernel modules a module developer expresses all of the data describing the module in a module metadata source file. The module metadata source file is in a special file format. In creating these files normal C data structures cannot be used because normal C data structures have embedded pointers, and pointers do not have usable values until the modules are linked into a complete kernel. The KC tools need to be able to extract the data before the kernel is completely configured. To overcome this limitation with C data structures, the embodiments described herein use contiguous, variant length data structures that do not have any embedded pointers.

Normal data structures also cannot be used because their use would require all modules to be recompiled whenever the structure definition changes. This is unacceptable in an environment where different modules are created by different authors in different companies at different times. To overcome this limitation with C data structures, the embodiments described herein use discriminated unions where the C data structures begin with special codes describing how the rest of the structures are interpreted.

As illustrated in the embodiment of FIG. 3, a module metadata source file 302 can be provided as a source file to the kernel development system. In the example embodiment illustrated in FIG. 3 a module's metadata source file 302 is first passed through a module metadata compiler 304 that translates the module metadata source file format into a series of C language data structures to produce a C source file. The resulting C source files are passed through a C compiler 306 to produce a module metadata object file 308 having the self describing metadata embedded therein. According to various embodiments, the C language data structures generated by the module metadata compiler 304 can be put into a special section of the modules object file 308 which contains only such data structures. To achieve this, a special instruction (“pragma”) is given to the C compiler 306, controlling the section into which data structures are placed. Although module object files typically have all of their data in a single section, an industry standard known “ELF” file format for object files allows multiple data section. As one of ordinary skill in the art will appreciate upon reading this disclosure, the ELF file format can be used with the embodiments described herein for self describing kernel modules to export to an invocation of a linker utility, i.e. 324 as described in more detail below.

As one of ordinary skill in the art will appreciate upon reading this disclosure, when modules are linked together using the linker utility 324 to form a complete kernel, the special ELF format sections used for each of the component modules' metadata are combined into a single section, separate from all other types of data, in the resulting kernel. This combination of section data is a feature of the linker utility 324 used by embodiments of the present invention.

An example of what has been described above can be found in copending application entitled, “Self-Describing Kernel Modules”, application Ser. No. 10/440,144, filed on May 19, 2003, assigned to the instant assignee, and incorporated by reference to which the current application is a continuation in part.

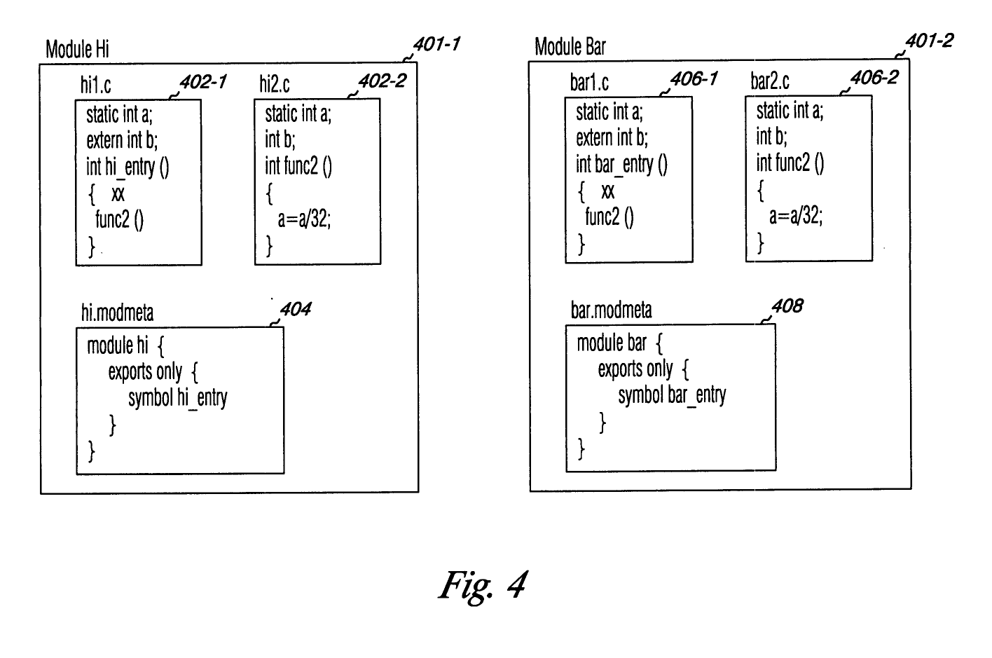

Thus, as one example embodiment the reader will appreciate that a developer may write (i.e., specify a particular type of information) into the module metadata source file 302 a list of symbols (i.e., functions and/or variables) to be exported as an “exports only” statement, from a self describing module, to a linker utility. According to various embodiments described herein, the self describing information in the module will include instructions to hide all global symbols except those mentioned in the “exports only” statement, e.g., written into the module metadata source file, by the module developer. An example of what is described in this paragraph is illustrated in connection with FIG. 4. As one of ordinary skill in the art will appreciate, absent this mechanism, each module can wind up making more symbols visible than desired. As noted above, where multiple modules make the same symbol visible, namespace collisions can occur, resulting in either build breakage or potentially significant system misbehavior.

One example of such collisions is given by the following. In certain Unix environments, a compiler tool chain automatically inserts into any module one or more “millicode functions”, which implement features of the programming language used by the module developer. This is done without the knowledge or intervention of the developer. Since these symbols may be inserted into any module, there is a potential that such symbols will be inserted into multiple modules, and thereby lead to a collision if two or more such modules are used. Embodiments of the present invention allow the millicode symbols in each such module to be hidden from the other modules, and thus avoid potential collision. In other words, by allowing developers control over which of their global symbols are visible to other users, the potential for such collisions can be reduced and the reliability of a system increased.

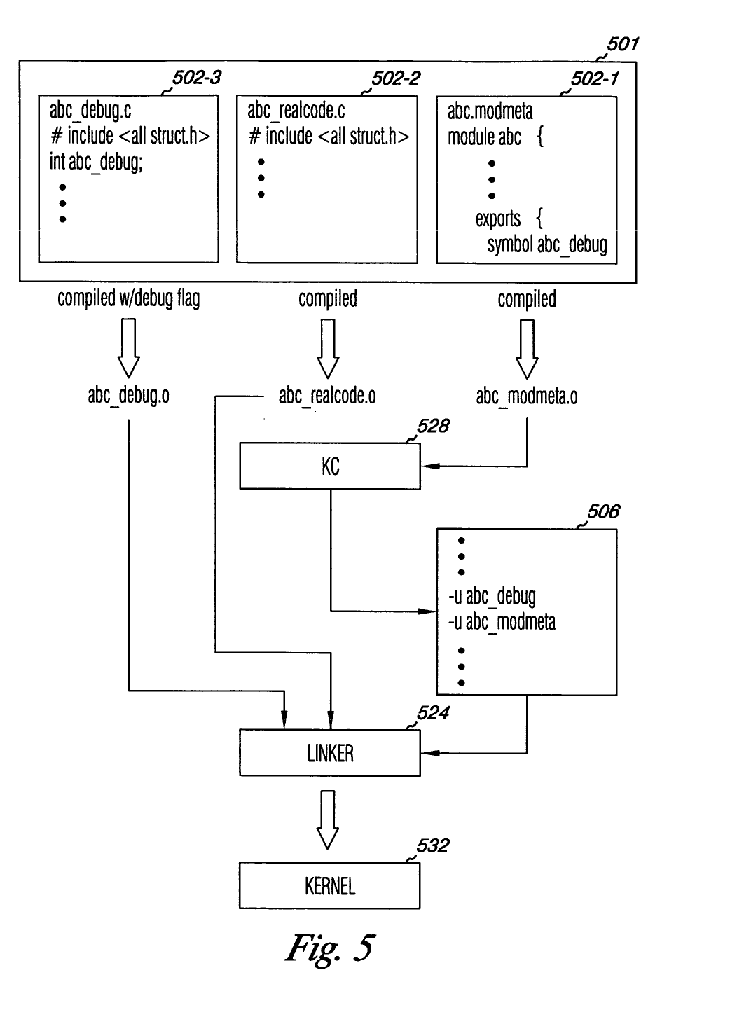

From reading further below the reader will also appreciate that as another example embodiment a developer may write (i.e., specify a particular type of information) into the module metadata source file 302 a list of symbols (i.e., functions and/or variables) to be exported as an “exports” statement, from a self describing module, to a linker utility. According to various embodiments described herein, the self describing information in the module will include instructions to export various object files that do not typically fit into the above mentioned categories of object files that are; (1) listed explicitly in the command line, e.g. usually required object files, and (2) contained in libraries listed on the command line and needed to resolve symbol references from each other or the explicitly listed object files. Thus, by way of example and not by way of limitation, the “exports” statement can include instructions to export: (1) debug information; (2) “what” string information; and (3) symbols that may be required by loadable modules, e.g., DLKMs that are not yet loaded. That is, various embodiments include instructions which allow module developers to force the linker to include object files by exporting symbols in the “exports” statement that can then be used in the linker command line to force inclusion of the object files that define those symbols. This approach allows modularity. The export symbol information in the “exports” statement is compiled into the modules. An example of what is described in this paragraph is illustrated in connection with FIG. 5.

Hence, FIG. 3 illustrates one mechanism to achieve the above described embodiments in a program build process. FIG. 3 is a conceptual flow chart of a Unix kernel build process. Embodiments, however, are not limited to a Unix environment or a kernel build process. The process illustrated in FIG. 3 centers around two invocations of the linker, 314 and 324. The first invocation is used to link together a module. This happens once for each module. The second invocation is used to join modules together to make a kernel. As will be described in more detail below, in each invocation of the linker, 314 and 324, the linker is given its instructions by a specialized build tool.

In the mechanism shown in FIG. 3, self describing module metadata object files 308, including a list of symbols to provide to the linker utility 314, is first provided to a module link tool 310. Program embodiments, i.e., computer executable instructions, are provided to the module link tool 310 (e.g., storable in memory) which can be executed thereon (e.g., using logic and processor resources as the same are appreciate by those in the art) to read the module metadata object file 308. The program embodiments further execute to translate information in the self describing module metadata object files 308 (created from the module metadata source file 302 written by the developer) to instructions which the linker utility 314 can operate on. Thus, in the example embodiment of FIG. 3, program embodiments executing on the module link tool 310 derive instructions 312 from the self describing module metadata object files 308 to provide to the linker 314. Embodiments, however, are not limited to self describing module metadata object files 308 and one of ordinary skill in the art will appreciate upon reading this disclosure other suitable techniques to provide instructions to a linker utility to include a list of symbols as defined by a module developer, e.g., either through the addition of “exports only” statements and/or “exports” statements.

According to the various embodiments described herein, module link tool 310 upon reading and translating the information in the self describing module metadata object files 308 provides linker instructions 312 to make visible, i.e., export to other modules, a list of symbols that a module developer wants to have visible to other modules along with a notation, i.e., instruction to the linker, indicating that all other symbols are to be hidden. In effect, the linker instructions 312 instruct the linker 314 to hide all global symbols except those mentioned in an explicit list of symbols (functions and variables) supplied by a developer.

One rationale for this approach is that since the developer may not know of all the global symbols in the module, e.g., millicode, the developer would not be able to provide a list of all the symbols that should not be visible, i.e., may result in collisions. However, with the above described embodiments, the developer can provide instructions to hide all global symbols from other modules except those affirmatively identified. In effect, these embodiments of the present invention, including the module link tool, allow the developer to add “exports only” statements, listing particular global symbols, into module metadata source files 302. The module link tool 310 can execute program embodiments to read and translate a self describing module metadata object file 308 created from the module metadata source files 302 in order to provide instructions 312 to a linker 314 to hide all global symbols except those explicitly included in the list. As one of ordinary skill in the art will appreciate, the linker 314 facility, once provided with instructions 312, has the capability to honor those instructions, thus producing modules, 322-1, 322-2, . . . , 322-N, that make visible, i.e., export to other modules, only the symbols requested in the developer provided list. The details of the linker 314 are not the subject of the present disclosure and according more detail pertaining to the same is not provided so as not to obscure the subject embodiments.

Additionally, according to various embodiments described herein, the self describing information in the module will include instructions to export various symbols, thus forcing the linker to include object files that do not typically fit into the above mentioned categories of object files that are; (1) listed explicitly in the command line, e.g. usually required object files, and (2) contained in libraries listed on the command line and needed to resolve symbol references from each other or the explicitly listed object files.

In these embodiments, a kernel configuration tool (kconfig) 328 upon executing program instructions to read and translate the information in the self describing modules, 322-1, 322-2, . . . , 322-N, also provides linker instructions 330 to instruct the linker 324 to include object files with: (1) debug information; (2) “what” string information; and (3) symbols that may be used by loadable modules, e.g., DLKMs (dynamically loadable kernel modules) that are not yet loaded. Thus, the various embodiments include instructions which allow module developers to force the linker 324 to include object files by exporting symbols in an “exports” statement that can then be used in the linker command line to force include the object files.

FIG. 3, further illustrates the completion of a program build process. As mentioned above, the build process generally involves two invocations of a linker. The discussion above centers around the first invocation of a linker, i.e., linker 314. As stated above, this first invocation is used to link together modules, i.e., independent code in machine language, shown as 322-1, 322-2, . . . , 322-N. The designator “N” is used to illustrate that a number of such modules can be created. In one example Unix environment, the operating system kernel is a collection of around 350 such modules. The process up through and including the invocation of linker 314 is performed in the development environment.

As shown in the example illustration of FIG. 3, once all of the modules, 322-1, 322-2, . . . , 322-N have been built in this fashion a second invocation of a linker 324 is used to join modules together to make a program, e.g., kernel. This part of the process may be performed in either the development environment or the runtime environment, i.e., on a customer system. As illustrated, the second invocation of a linker 324 receives instructions 330 from the kernel configuration tool (kconfig) 328, which reads the modules, 322-1, 322-2, . . . , 322-N, to find out what modules are available. The kernel configuration tool 328 can allow a system administrator to specify tunable variables, i.e., values that control the behavior of the modules, 322-1, 322-2, . . . , 322-N. Such administrator chosen values can be contained in customer system files 326. The customer supplied “system file” 326 also specifies which modules the customer wants to use. The result of this process is a complete program, e.g., kernel file 332, that the customer can use to run their system.

FIG. 4 serves to illustrate considerations which exemplify the benefits of the module link tool 310, shown in FIG. 3, and the program embodiments described herein for providing “exports only” statements to modules which list the symbols which will be visible outside of a module along with a notation indicating that all other symbols are to be hidden. The illustration in FIG. 4, depicts a pair of modules, 401-1 and 401-2. Each module is illustrated with three source files (two code files and one module metadata file), i.e., 402-1, 402-2, 404 in module “Hi” 401-1 and 406-1, 406-2, 408 in module “Bar” 401-2. In this example, source files 402-1 and 402-2 in module 401-1 are code files labeled hi1.c and hi2.c respectively, and source file 404 in module 401-1 is a module metadata file, as the same has been described herein, labeled hi.modmeta. Likewise, in this example, source files 406-1 and 406-2 in module 401-2 are code files labeled bar1.c and bar2.c respectively, and source file 408 in module 401-2 is a module metadata file labeled bar.modmeta. Each of the code source files, 402-1, 402-2, 406-1, and 406-2 shows variables and functions whose names (i.e., symbols) must be handled correctly for proper operation of the overall system.

In the example illustrate in FIG. 4, all four code source files, 402-1 and 402-2 in module 401-1 and 406-1 and 406-2 in module 401-2, have a static variable “a”, shown as “static int a;”. Since the variable is static, each file has its own separate variable by that name, and cannot see the variables of that name that belong to the other files. Further as illustrated in FIG. 4, both modules 401-1 and 401-2 have a global variable “b”, shown as “extern int b;”, and defined by the second source file in each module and referenced by the first, i.e., source files 402-2 and 406-2 define “int b;”. Both modules 401-1 and 401-2 have a function named “xx_entry”, where xx is the name of the module, i.e., hi and bar respectively, shown in source files 402-1 and 406-1. Both modules have a function named “func2”, defined in the second source file, i.e., 402-2 and 406-2, in each module and called from the first source file, i.e., 402-1 and 406-1. Both modules contain an instruction that does an integer divide by a constant power of two, shown in source files 402-2 and 406-2 as “a=a/32”. This is one of many operations that can be internally implemented by calling a millicode function.

In the example embodiment of FIG. 4, the hi.modmeta source file 404 and the bar.modmeta source file 408 in modules 401-1 and 401-2 respectively provide an “exports only” statement as the same has been described herein. As such, according to the various embodiments of the present invention, only particular symbols, listed by a developer therein, will be exported or made visible outside of these respective modules according to the instructions 312 given to the linker utility 314 by the module link tool 310 represented in FIG. 3.

As the reader will appreciate, one advantage afforded by embodiments of the present invention is the reduction of conflicts between modules, e.g., 401-1 and 401-2. The modules 401-1 and 401-2 illustrated in FIG. 4 may have been written by different companies, each unaware of the other. Absent the embodiments described herein, these two modules could not have been used in the same program, because of at least three conflicts. These three conflict examples include the following. First, both modules 401-1 and 401-2 define a global variable “b”. Global variables are visible throughout the program and there can only be one definition of each. Because of this conflict, an attempt to put these two modules in the same program would result either in build failure (i.e., a “duplicate symbol” error) or system misbehavior (i.e., resulting from both modules 401-1 and 401-2 referencing the same storage location for “b”). Second, both modules 401-1 and 401-2 define a global function “func2”. Global functions are likewise visible throughout the program, and there can only be one definition of each. Because of this conflict, an attempt to put these two modules in the same kernel would result in build failure. And third, the arithmetic operation in each “func2” function will cause the compiler to request, and the linker to provide, a millicode function to handle the operation “a=a/32”. As mentioned earlier, millicode functions are very efficient code subroutines used to handle some constructions in high level languages. Millicode functions are also global functions, so this would result in the same sort of conflict as with “func2”. This third example is somewhat more nettlesome because the code developers are not even aware that they are using a millicode function, much less that it might cause a conflict.

By use of the embodiments described herein, including a module link tool and the program embodiments associated therewith, the addition of “exports only” statements in the two modmeta source files, the occurrence of such above described issues can be reduced. As described in detail above, the use of these statements list the symbols (variables or functions) that should be visible outside the module; all others are hidden so that they cannot cause conflicts.

Another advantage is noted here in connection with the “exports only” embodiment of FIG. 4. That is a key principle of modularity is exposing to users of a module only the supported interfaces to it. In some large software systems, absent a mechanism as described herein, users of a module can “see”, and therefore may call, functions that are internal to the module and not supposed to be used outside of the module. Similarly users can see, or even modify, variables belonging to the module. This can happen either through lack of understanding of the module or through careless or deliberate misuse. By forcing all symbols to be hidden except for the supported interfaces, a module developer can prevent such mistakes, and thereby reduce support costs. This is doubly important when the user is a customer. That is, if the customer sees, and starts using an interface that is not intended for their use, then the developer may have to take on the burden of having to support it indefinitely. This may cause the developer to lose flexibility in maintenance of their code.

FIG. 5 serves to illustrate considerations which exemplify the benefits of the kconfig tool 328, shown in FIG. 3, and the program embodiments described herein for providing “exports” statements to modules that list the symbols which can be used in the linker command line to include, by way of example and not by way of limitation: (1) debug information; (2) “what” string information; and (3) symbols that may be used by loadable modules, e.g., DLKMs that are not yet loaded.

FIG. 5 illustrates an example embodiment for building an operating system kernel with object files having information about kernel data structures, e.g., debug information, that are visible to the kernel debugger and useful for debugging purposes. However, embodiments for the “exports” statement usage are not limited to the example use of debugging provided in FIG. 5.

FIG. 5 illustrates a module, e.g., 322-1, 322-2, . . . , 322-N, as shown in FIG. 3, which has been linked by the first invocation of a linker, i.e., 314, using instructions 312 provided by the above described module link tool 310. In the example embodiment of FIG. 5 a kernel module called “abc” 501 is undergoing a process of being linked into the operating system kernel. The module 501 is illustrated with three source files (one module metadata file and two code files), i.e., 502-1, 502-2, and 502-3. The module metadata file 502-1, labeled “abc.modmeta” describes the module, as the same has been described above. As shown in the example embodiment of FIG. 5, abc.modmeta file 502-1 includes an “exports” statement, as the same has been described herein, to export the symbol “abc_debug”.

Code file 502-2, labeled “abc_realcode.c”, contains the implementation of the module, as understood by one of ordinary skill in the art. Code file 502-3, labeled “abc_debug.c”, is the file which is compiled with special debug options to make sure that any data structure described there is visible to the kernel debugger. All of the C source files include a header file called “allstruct.h” (not shown in FIG. 5). As understood by one of ordinary skill in the art, the assumption here is that this header file contains all the data structures used within the kernel module abc. It is also worth noting, however, that the implementation of the module (code file 502-2) is not compiled with the debug option because of performance issues.

As mentioned, the above description in connection with FIG. 3 is applicable here as well. That is, in the example embodiment of FIG. 5 various object files are shown, illustrated as abc_modmeta.o, abc_realcode.o, and abc_debug.o, that have been created by the above described compilation process (i.e., FIG. 3 and denoted here by block arrows).

At the time of the kernel build process, the kernel configuration tools 528, as described in connection with FIG. 3, read information compiled into the modmeta object file, i.e. abc_modmeta.o, and execute program instructions to generate linker instructions 506 (shown as 330 in FIG. 3). These linker instructions can be referred to as “1dopts” file. When filling in the linker instructions, program embodiments associated with the kernel configuration tools 528 execute to include a line in the linker command line which instructs the linker 524 to pull in the object file which describes the symbol abc_debug (shown in the FIG. 5 as “-u abc_debug”) and this pulls in the abc_debug.o object file into the kernel 532.

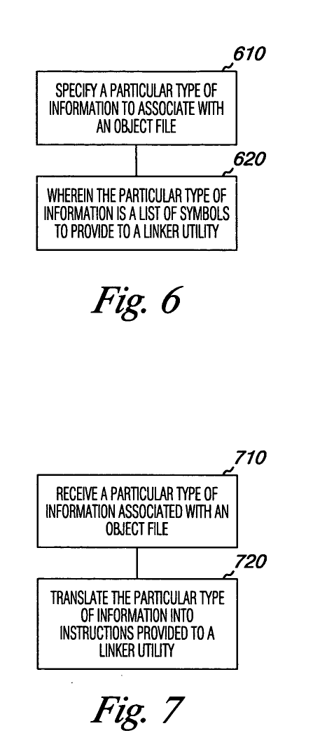

FIGS. 6-7 illustrates various method embodiments for handling module symbols. As one of ordinary skill in the art will understand, the embodiments can be performed in connection with program embodiments, i.e., computer executable instructions, operable on the systems and devices shown herein or otherwise. Embodiments of the invention, however, are not limited to any particular operating environment or to software written in a particular programming language. Program embodiments suitable for carrying out embodiments of the present invention, can be resident in one or more devices or locations or in several and even many locations.

FIG. 6 illustrates one method embodiment for handling module symbols. In the embodiment of FIG. 6, the method includes specifying a particular type of information to associate with an object file as shown in block 610. As one of ordinary skill in the art will appreciate upon reading this disclosure, specifying a particular type of information includes employing any of the techniques and mechanisms described in detail above or otherwise recognized as suitable by one of ordinary skill in the art. In one embodiment specifying a particular type of information to associate with an object file can include specifying a particular type of information to embed in module metadata of an object file. For example, as described above, specifying a particular type of information can include a developer using a high level programming code to create a module metadata source file which will embed various type of information which once the module metadata source file is compiled into an object file. As shown in the embodiment of FIG. 6 at block 620, the method includes that the particular type of information is a list of symbols provided as appropriate instructions to a linker utility. As described herein, the list of symbols can be the addition of “exports only” statements instructing the linker to produce modules that export only the symbols requested and/or the addition of “exports” statements to include, by way of example and not by way of limitation: (1) debug information; (2) “what” string information; and (3) symbols that may be used by loadable modules, e.g., DLKMs that are not yet loaded. Again, the reader will appreciate that the list of symbols provided as appropriate instructions to a linker can employ any of the techniques and mechanisms described in detail above. For example, this can employ program embodiments executing in conjunction with a module link tool as the same has been described above.

FIG. 7 illustrates another method embodiment for handling module symbols. In the embodiment of FIG. 7, the method includes receiving a particular type of information associated with an object file as shown in block 710. As one of ordinary skill in the art will appreciate upon reading this disclosure, receiving a particular type of information associated with an object file can include receiving a particular type of information embedded as module metadata in an object file. Embodiments, however, are not so limited. As the reader will appreciate receiving a particular type of information embedded as module metadata in an object file includes employing any of the techniques and mechanisms described in detail above. For example, receiving a particular type of information embedded as module metadata in an object file can include using a module link tool, as the same has been described above, to receive the module metadata in the object file. This particular object file may have been created by taking a module metadata source file (written by a code developer) and passing it through a module metadata compiler and then a C compiler as described above.

As shown in the embodiment of FIG. 7 at block 720, the method includes translating the particular type of information into instructions provided to a linker utility. For example, as has been described herein, translating the particular type of information can include translating “exports only” statements into instructions provided to a linker to produce modules which make visible only symbols listed, i.e., specified in the particular type of information. Likewise, translating the particular type of information can include translating “exports” statements into instructions provided to a linker to include, by way of example and not by way of limitation: (1) debug information; (2) “what” string information; and (3) symbols that may be used by loadable modules, e.g., DLKMs that are not yet loaded. Again, the reader will appreciate that translating the particular type of information into instructions for a linker can employ any of the techniques and mechanisms described in detail above. For example, this can employ program embodiments executing in conjunction with a module link tool and/or a kconfig tool as the same have been described above.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the invention. It is to be understood that the above description has been made in an illustrative fashion, and not a restrictive one. Combination of the above embodiments, and other embodiments not specifically described herein will be apparent to those of skill in the art upon reviewing the above description. The scope of the various embodiments of the invention includes any other applications in which the above structures and methods are used. Therefore, the scope of various embodiments of the invention should be determined with reference to the appended claims, along with the full range of equivalents to which such claims are entitled.

In the foregoing Detailed Description, various features are grouped together in a single embodiment for the purpose of streamlining the disclosure. This method of disclosure is not to be interpreted as reflecting an intention that the embodiments of the invention require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

1. A module build tool, comprising:
a processor;
a memory coupled to the processor; and
program instructions provided to the memory and executable by the processor to:
specify a particular type of information to associate with an object file; and
wherein the particular type of information is a list of symbols to export to a linker utility.

2. The build tool of claim 1, wherein the list of symbols includes variables and functions that are intended to be visible outside of a linked module.

3. The build tool of claim 1, wherein the particular type of information includes notation that all symbols not included in the list of symbols are to be hidden from being viewable outside of a linked module.

4. The build tool of claim 1, wherein the program instructions execute to read the particular type of information associated with an object file and execute to translate the particular type of information into instructions executable by the linker utility.

5. The build tool of claim 4, wherein the particular type of information includes information embedded in module metadata of an object file.

6. A module link tool, comprising:
a processor;
a memory coupled to the processor; and
program instructions provided to the memory and executable by the processor to:
receive a particular type of information associated with an object file; and
translate the particular type of information into instructions provided to a linker utility.

7. The module link tool of claim 6, wherein the particular type of information is a list of symbols that must be visible outside of a module.

8. The module link tool of claim 6, wherein the instructions provided to the linker utility instruct the linker utility to produce modules which export only listed symbols and to hide all other symbols.

9. The module link tool of claim 6, wherein instructions are to hide all global symbols except those mentioned in an explicit list.

10. The module link tool of claim 6, wherein the particular type of information is embedded as module metadata in the object file.

11. A method for handling modules, comprising:
specifying a particular type of information to associate with an object file; and
translating the particular type of information into instructions for a linker utility.

12. The method of claim 1 1, further including:
embedding statements in a module metadata source file;
passing the module metadata source file through a module metadata compiler and a C compiler to create a module metadata object file; and
translating embedded statements received from the module metadata object file using a module link tool.

13. The method of claim 12, wherein the method further includes providing instructions, including the translated statements, to a linker utility.

14. The method of claim 12, further including embedding “exports only” statements in the module metadata source file.

15. The method of claim 14, wherein embedding “exports only” statements includes a list of variables and functions which will be visible outside of a module.

16. The method of claim 12, wherein translating embedded statements received from the module metadata object file includes providing instructions to a linker utility such that the linker utility produces modules that export only requested symbols.

17. The method of claim 12, further including embedding “exports” statements in the module metadata source file.

18. A computer readable medium having a program to cause a device to perform a method, comprising:
reading a particular type of information embedded as module metadata in an object file; and
translating the particular type of information into instructions for a linker to produce modules which make visible symbols listed in the particular type of information.

19. The medium of claim 18, wherein the instructions include a notation to hide all other symbols.

20. The medium of claim 19, wherein the notation to hide all other symbols includes instructions to hide global symbols introduced by build tools on behalf of, but without explicit action by a module developer.

21. The medium of claim 19, wherein the notation to hide all other symbols includes to hide millicode from being visible outside of a linked module.

22. The medium of claim 18, wherein the particular type of information includes exports only statements.

23. The medium of claim 18, wherein the particular type of information includes exports statements.

24. The medium of claim 18, wherein the object file includes an object file created from a module metadata source file which has been passed through a module metadata compiler and a C compiler.

25. A software development system, comprising:
a source file including a particular type of information to be associated with an object file;
a compiler to receive the source file and to produce the object file; and
a module link tool, wherein the module link tool includes program instructions to:
receive the particular type of information associated with the object file; and
translate the particular type of information into instructions provided to a linker utility.

26. The system of claim 25, further including a linker to receive instructions from the module link tool and to produce modules that export only requested symbols.

27. The system of claim 26, wherein the system produces modules which can further be used in a runtime environment as part of a kernel build process.

28. The system of claim 25, wherein the system further includes:
a module metadata source file;
a module metadata compiler to receive the module metadata source file and produce a C source file;
a C compiler to receive the C source file and produce a module metadata object file;
code source files written in various languages; and
one or more compilers to receive the codes source files as suited to a particular code language and to produce one or more code object file therefrom.

29. The system of claim 28, wherein the linker can receive the one or more code object files and produce modules therefrom.

30. A module build system, comprising:
means for associating particular types of information with an object file, wherein the particular type of information includes a list of symbols that will be visible outside of a linked module; and
means for hiding all other symbols outside of the linked module.

31. The module build system of claim 30, wherein the means for hiding all other symbols includes:
reading embedded export only statements from an object file; and
translating the embedded export only statements to a linker utility.

32. The module build system of claim 31, wherein reading and translating is performed using a module link tool having a set of program instructions.

33. The module build system of claim 32, further including a linker having a facility to hide all symbols except those contained in the list.

34. The module build system of claim 30, wherein the means includes implementing self-descriptive data in a module.

35. A module build system, comprising:
means for avoiding namespace collisions for modules created independently by different developers; and
means for providing a linker with:
object files having debug information;
object files with “what” string information; and
object files with symbols that may be required by loadable modules.

36. A module build tool, comprising:
a processor;
a memory coupled to the processor; and
program instructions provided to the memory and executable by the processor to:
receive a particular type of information associated with an object file, wherein the particular type of information includes a list of symbols to export to a linker utility to be made visible outside of a linked module and includes a notation that all symbols not included in the list of symbols are to be hidden from being visible outside of the linked module; and
wherein the program instructions execute to read the particular type of information associated with the object file and execute to translate the particular type of information into instructions executable by the linker utility.

37. The build tool of claim 36, wherein the particular type of information includes information embedded in module metadata of the object file.

38. A computer readable medium having a program to cause a device to perform a method, comprising:
reading a particular type of information associated with an object file, wherein the particular type of information includes a list of symbols to export to a linker utility to be made visible outside of a linked module and includes a notation that all symbols not included in the list of symbols are to be hidden from being visible outside of the linked module; and
translating the particular type of information into instructions for the linker utility to produce modules which make visible symbols listed in the particular type of information and to produce modules which hide all other symbols from being visible outside of the linked module.

39. The medium of claim 38, the method further including:
embedding statements representing the particular type of information in a module metadata source file; and
passing the module metadata source file through a module metadata compiler and a C compiler to create a module metadata object file having the particular type of information.

40. The medium of claim 39, wherein translating the particular type of information includes translating the information received from the module metadata object file using a module link tool.

41. The medium of claim 39, further including embedding “exports only” statements in the module metadata source file.

42. The medium of claim 39, further including embedding “exports” statements in the module metadata source file.
